(19) United States
(12) Patent Application Publication
(10) Pub. No.: US 2015/0118527 A1
(43) Pub. Date: Apr. 30, 2015

(54) BATTERY AND MOTOR VEHICLE HAVING THE BATTERY ACCORDING TO THE DISCLOSURE

(71) Applicants: Samsung SDI Co., Ltd., Yongin-si (KR); Robert Bosch GmbH, Stuttgart (DE)

(72) Inventors: Frank Stimm, Stuttgart (DE); Michael Steil, Korntal-Muenchigen (DE); Alfons Doerr, Stuttgart (DE); Andreas Bosch, Oberriexingen (DE)

(73) Assignees: Samsung SDI Co., Ltd., Yongin-si (KR); Robert Bosch GmbH, Stuttgart (DE)

(21) Appl. No.: 14/061,815

(22) Filed: Oct. 24, 2013

(51) Int. Cl. H01M 2/34

(52) U.S. Cl. CPC H01M 2/345
USPC 429/61

(57) ABSTRACT

A battery includes at least one galvanic cell enclosed in one cell housing in each case and a pressure-sensitive diaphragm in the cell housing. The diaphragm is configured to react to at least one discrete degree of pressure difference with at least one discrete degree of deformation. A signal encoder is positioned in the operative region of a deformation of the diaphragm. The battery has at least one electric switching element operatively connected to the signal encoder and configured to disconnect a main electric current of the battery. A motor vehicle is connected to the battery.

This application claims priority under 35 U.S.C. §119 to patent application no. DE 10 2012 219 389.8, filed on Oct. 24, 2012 in Germany, the disclosure of which is incorporated herein by reference in its entirety.

### BACKGROUND

The present disclosure relates to a battery and a motor vehicle connected to the battery, wherein the battery comprises at least one galvanic cell which is arranged inside a cell housing, and a pressure-sensitive diaphragm.

A gas-tight lithium accumulator cell can, under certain circumstances, for example in the case of excess charging, overloading or even in the case of a deep discharge, release gases which, under certain circumstances, generate a high pressure in the interior of the cell housing. In order to prevent a further pressure increase and possibly resulting destruction of the accumulator cell ranging as far as what is referred to as “thermal runaway”, an “excess charge protector” is integrated into the gas-tight lithium accumulator cell. Said “excess charge protector” comprises a small thin metallic plate which, in the case of overpressure, changes its shape and generates a short-circuit between the electrical poles of the cell. The short-circuit current activates a fuse internal to the cell to interrupt the current and therefore continuation of the current flow is avoided. As a result, in a first approximation an inherently safe state of the cell is brought about.

DE 10 2011 053 701 A1 discloses an arrangement of lithium-ion polymer cells for avoiding the risk of fire and/or explosion in the case of excess charging, a deep discharge or mechanical damage as well as when there is an increase in temperature and pressure.

DE 10 2008 059 958 A1 discloses a protection device which protects a lithium-ion battery cell against increased temperature and an increased internal pressure in the event of a malfunction.

DE 30 39 809 A1 discloses a device for improving the safety owing to expansion of the cell volume of a round cell owing to the generation of gas.

### SUMMARY

According to the disclosure, a battery is made available which comprises at least one galvanic cell which is arranged inside a cell housing, wherein the battery comprises a pressure-sensitive diaphragm which is formed as part of the cell housing, and the diaphragm is designed to deform as a function of a pressure difference between the inside of the cell housing and the outside of the cell housing, and the battery comprises a signal encoder which is arranged in the region of the diaphragm, wherein the battery has at least one electric switching element which is operatively connected to the signal encoder and is designed to disconnect a main electric current of the battery.

Each cell is preferably arranged in one cell housing with at least one diaphragm and at least one signal encoder, wherein according to the disclosure the signal encoder does not switch a main current, that is to say a main current preferably cannot flow through it, but instead said signal encoder merely generates a switching signal which is connected to a switch, a relay, a pyroswitch or a fuse, preferably located outside the cell housing and preferably switching a main current which flows through a plurality of cells, in order to activate the switch, the relay, the pyroswitch or the fuse to disconnect the main current. Each module preferably has in each case a signal encoder and in each case at least one switching element for disconnecting the main current. A module preferably has more than one switching element for disconnecting the main current in order to be able to disconnect the electrical poles from a voltage and a current on both sides.

In a further preferred variant, each cell has a signal encoder which is connected through a line bus structure via modules to at least one switching element, preferably to two switching elements, for disconnecting the main current of the module arrangement or of the battery, in order to be able to disconnect the electrical poles of the battery from a voltage and a current on both sides.

An advantage provided by the disclosure is that in the event of damage the battery cell is placed in a nondamaging state, and a short-circuit at the overloaded cell, which would entail a flow of current for further cells, is avoided. Further cells are therefore protected against incorrect use. There is also no need anymore for a high short-circuit current with a resulting disconnection of an internal fuse in order to deactivate the overloaded cell. This protects the overloaded cell against further loading and against what is referred to as “thermal runaway”. The disclosure also protects against an inevitably strong light arc at a fuse since a short-circuit current which brings about the disconnection of the fuse is no longer necessarily connected. The possibility of the cell housing melting and the possibility of the electrolyte catching fire are therefore likewise avoided. Likewise, the disclosure avoids the situation in which a high reverse voltage, “reverse polarity”, which is caused by the other cells, occurs as a result of a short-circuit at the system level, which brings about disconnection of the cell fuse. As a result, the possibility of electrochemical reactions of dangerous severity at the deactivated cell is likewise avoided.

In one preferred embodiment, the electric switching element is a relay.

One advantage is the possibility that, in the event of damage in a cell, the entire module or the entire system is protected, for example by interrupting the conductive connection to an external consumer or to a charging device.

The electric switching element is preferably a pyrotechnic switch.

A resulting advantage is that the entire battery pack can therefore be disconnected electrically and the possibility of further damage by external influences is avoided.

A multiplicity of pressure-sensitive diaphragms is preferably arranged in and/or on the cell housing, and each cell is assigned a multiplicity of signal encoders in order to be able to detect a multiplicity of pressure differences.

It is advantageous that a multi-stage warning system with early detection and a multi-stage system response can be installed.

In one particularly preferred variant, the signal encoder has an element for measuring an electric voltage of the galvanic cell.

This has the advantage that an intrinsically safe state of the overall system can be brought about quickly and in good time.

It is preferred that the galvanic cell is a lithium-ion cell.

An advantage which is obtained is that lithium is easily and favorably available as a resource.

The signal encoder can preferably be arranged on a cover of the galvanic cell.

An advantage which is achieved as a result is a reduced susceptibility to faults owing to line routes which are made as short as possible.

Two switching elements are connected to two connection terminals of the battery, as an additional variant, and are designed to disconnect an electric voltage of the battery from both connection terminals.

Electrical disconnection is also advantageous here since, in particular, electrical disconnection occurs on both sides and therefore both contacts/terminals are switched to a state which is free of current and free of voltage.

It is also preferred that the connection of a first signal output of the first signal encoder to a second signal output of the second signal encoder has a line bus structure.

It proves advantageous that the line routes are thereby shortened, and therefore the functional reliability is improved.

With respect to a further aspect of the disclosure, a motor vehicle having a battery according to one of the previously mentioned features is disclosed, wherein the motor vehicle is connected electrically and mechanically to the battery.

The battery according to the disclosure is advantageously used in a motor vehicle, wherein, in particular, the improved safety is significant.

According to one preferred variant of the disclosure, a battery is made available which comprises at least one galvanic cell, which is enclosed in one cell housing in each case, and a pressure-sensitive diaphragm in the cell housing, which diaphragm is designed to react to at least one discrete degree of pressure difference with at least one discrete degree of deformation, and a signal encoder in the operative region of a deformation of the diaphragm, wherein the battery has at least one electric switching element which is operatively connected to the signal encoder and is designed to disconnect a main electric current of the battery.

It is also possible that the diaphragm is connected to a strain gauge or some other element which is suitable for detecting a different degree of deformation of the diaphragm, as a result of which a continuous or finely quantized value range of the bending of the diaphragm can be detected. In this case, the strain gauge is a signal encoder. The electronics for the strain gauge are a further signal encoder.

The housings of the cells are preferably of gas-tight design, with the result that a fluid cannot take place from the interior of the housings until a certain housing internal excess pressure is exceeded, by means of excess pressure valves or burst openings which are preferably integrated into the housing wall. Each cell preferably has a diaphragm and a signal encoder which respectively detects the various deflections of the diaphragm and is capable of differentiating them with respect to the multiplicity of signals thereof.

### BRIEF DESCRIPTION OF THE DRAWINGS

Exemplary embodiments of the disclosure are explained in more detail with respect to the drawings and the following description. In said drawings:

FIG. 1 shows a two-dimensional schematic illustration of a galvanic lithium-ion element with an excess pressure diaphragm according to the disclosure in accordance with one preferred embodiment variant, and

FIG. 2 shows a two-dimensional schematic illustration of a preferred embodiment variant of the battery according to the disclosure with a pyrotechnic switch.

### DETAILED DESCRIPTION

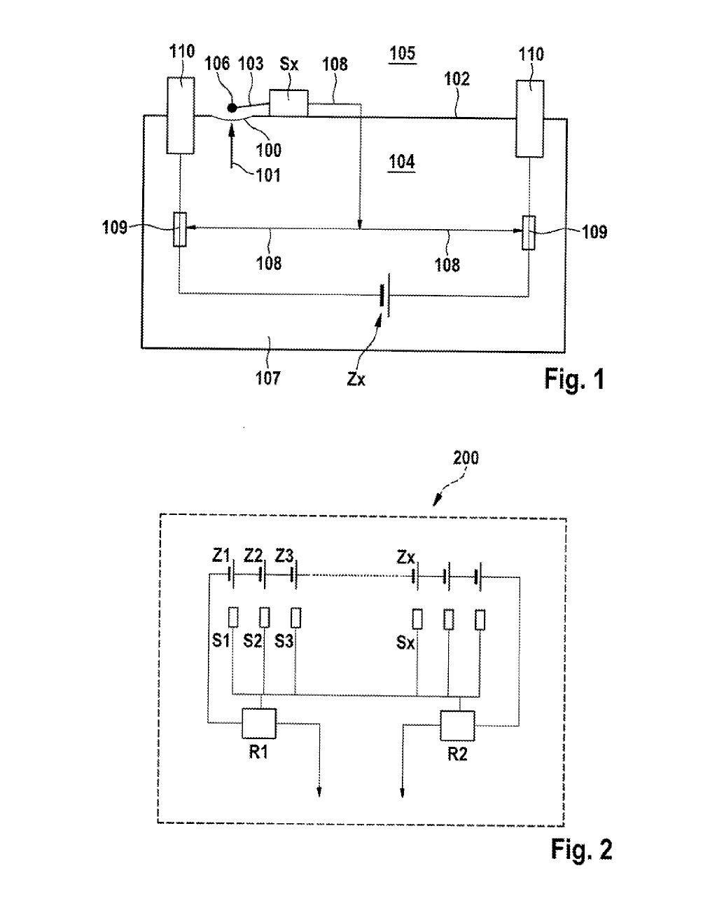

FIG. 1 shows a two-dimensional schematic illustration of a preferred embodiment variant of a galvanic lithium-ion element Zx, which is also referred to as “cell Zx”. Here, “x” is a serial index which indicates that a multiplicity of cells Zx is stacked in the preferred variant.

An internal pressure acts from an inside 104 of the cell housing 107, and from an outside 105 of the cell housing 107, on a metallic, electrically conductive excess pressure diaphragm 100, integrated into a cell cover 102. A pressure difference between the internal pressure and external pressure carries out deformation work as excess pressure 101 on the diaphragm 100, with the result that the diaphragm 100 curves in the case of excess pressure 101. The orientation of the curvature depends on whether the interior 104 of the housing has an excess pressure, in which case the diaphragm 100 curves outward, or an underpressure, in which case the diaphragm 100 curves inward.

According to the disclosure, arranged in the operative region of the curvature of the diaphragm 100 is a moveable element, preferably a mechanical lever 103 which is activated as a result of a change in the diaphragm curvature, and subsequently activates an electric switching element Sx arranged on the outside of the cell cover 102. A region which is located between a maximum internal curvature and a maximum external curvature of the diaphragm 100 is the operative region of the curvature. The curvature of the diaphragm 100 within two specific limits for an internal curvature and an external curvature is preferably an elastic and therefore reversible deformation.

When a plurality of diaphragms 100 are arranged in a cell Zx, various degrees of deflection can be respectively implemented with respect to a specific excess pressure by varying the diaphragm thicknesses.

In this context, “x” is a serial index which indicates that in the preferred variant a plurality of switching elements Sx are arranged in the region of an excess pressure diaphragm 100 in such a way that the curvature-dependent switching thresholds of the switching elements Sx differ from one another.

A multiplicity of degrees of excess pressure 101 can be logically coupled with a multiplicity of events by means of the inventive mapping of a plurality of degrees of curvature of the excess pressure diaphragm 100 onto various electric switching states. An event for an excess pressure 101 which is preferably the strongest to be registered could be, for example, the electrical disconnection of the poles from the galvanic element Zx or activation of a cell fuse, preferably a pyrotechnic fuse.

It is also possible for the multiplicity of stacked cells Zx each to have at least one switching element Sx, wherein the switching elements Sx are electrically connected to one another.

An event for an excess pressure 101 which is, for example, the weakest to be registered could be, for example, the triggering of a warning message or the activation of a system reaction.

In one preferred embodiment of the disclosure, the element Sx does not serve as a switch but instead as an electrical connection and as a mechanical securing means for a lever 103 which is embodied so as to be electrically conductive and mechanically elastically flexible and which is connected to the securing means Sx in an electrical and mechanical fashion. An electric contact element 106 is located at an end of the lever 103 remote from the securing means. In the case of an internal excess pressure 101, the electrically conductive diaphragm 100 curves in the direction of the contact element 106 and brings about electrical contact between the diaphragm 100 and the contact element 106 starting from a certain excess pressure 101.

FIG. 2 shows a two-dimensional schematic illustration of a preferred embodiment variant of the battery according to the disclosure which has a multiplicity of galvanic cells Zx which are stacked one on the other, wherein “x” is a serial index and also comprises the respective numerical index of the cells Z1, Z2 and Z3.

For each cell Zx there is preferably at least one respectively corresponding switching element Sx which is activated by a respectively predefined degree of internal excess pressure 101.

In one preferred embodiment of the disclosure, the element Sx does not serve as a switch but instead as an electrical connection and as a mechanical securing means for a lever 103 which is embodied so as to be electrically conductive and mechanically elastically flexible and is electrically and mechanically connected to the securing means Sx. An advantage which is achieved thereby is simplified line routing, since in this case the electrical connection poles S1, S2, S3 and Sx can be switched electrically in parallel and can therefore be routed on the shortest possible path from one cell Z1 to the next cell Z2.

In the case of an excess pressure 101, owing to a curvature of the diaphragm 100 an electric switching process is activated in the region of the cell cover 102, which switching process disconnects the entire accumulator pack, the stacked cells Zx, from a consumer or from a charging device. The disconnection from the consumer or from the charging device takes place, for example, by means of a first interruption relay R1 and preferably by means of a second interruption relay R2, in order to be able to electrically disconnect both poles.

One preferred embodiment, as an alternative to the interruption relays R1 and R2, has pyrotechnic switches or pyrotechnic fuses, also referred to as pyro-fuses. These have the advantage of being able to reliably and quickly disconnect high currents by means of an electrochemical reaction without requiring electronic logic components (active components).

What is claimed is:

1. A battery, comprising:
at least one galvanic cell arranged inside a cell housing;
a pressure-sensitive diaphragm formed as part of the cell housing, the diaphragm being configured to deform as a function of a pressure difference between the inside of the cell housing and the outside of the cell housing;
a signal encoder arranged in the region of the diaphragm; and
at least one electric switching element operatively connected to the signal encoder and configured to disconnect a main electric current of the battery.

2. The battery according to claim 1, wherein the electric switching element is a relay.

3. The battery according to claim 1, wherein the electric switching element is a pyrotechnic switch.

4. The battery according to claim 1, wherein a multiplicity of pressure-sensitive diaphragms is one or more of arranged in the cell housing and arranged on the cell housing, and a multiplicity of signal encoders is assigned to each cell so as to detect a multiplicity of pressure differences.

5. The battery according to claim 1, wherein the signal encoder has an element configured to measure an electric voltage of the galvanic cell.

6. The battery according to claim 1, wherein the galvanic cell is a lithium-ion cell.

7. The battery according to claim 1, wherein the signal encoder is arranged on a cover of the galvanic cell.

8. The battery according to claim 1, wherein two switching elements are connected to two connection terminals of the battery and are configured to disconnect an electric voltage of the battery from both connection terminals.

9. The battery according to claim 1, wherein the connection of a first signal output of a first signal encoder to a second signal output of a second signal encoder has a line bus structure.

10. A motor vehicle, comprising:
a battery, the battery including:
at least one galvanic cell arranged inside a cell housing;
a pressure-sensitive diaphragm formed as part of the cell housing, the diaphragm being configured to deform as a function of a pressure difference between the inside of the cell housing and the outside of the cell housing;
a signal encoder arranged in the region of the diaphragm; and
at least one electric switching element operatively connected to the signal encoder and configured to disconnect a main electric current of the battery,
wherein the motor vehicle is connected electrically and mechanically to the battery.
